(19) United States
(12) Patent Application Publication
(10) Pub. No.: US 2023/0196386 A1
(43) Pub. Date: Jun. 22, 2023

(54) SYSTEMS AND METHODS FOR LINKING A PRODUCT TO EXTERNAL CONTENT

(71) Applicants: Gregory Renard, REDWOOD CITY, CA (US); Chandra Bikkanur, Strongsville, OH (US); Marc Sun, Paris (FR)

(72) Inventors: Gregory Renard, REDWOOD CITY, CA (US); Chandra Bikkanur, Strongsville, OH (US); Marc Sun, Paris (FR)

(21) Appl. No.: 17/553,751

(22) Filed: Dec. 16, 2021

(51) Int. Cl. G06Q 30/02

(52) U.S. Cl. CPC G06Q 30/0201; G06Q 50/01

(57) ABSTRACT

Systems and methods are disclosed to automatically associate a product or a service with external content by characterizing the product from unstructured data sources including a product text or text from similar products; generating a label for the product or service; applying the label as a search engine; extracting signals relating to the product or service; and providing business intelligence for the product or service.

This application claims priority to application Ser. No. ______ entitled “SYSTEMS AND METHODS FOR PROVIDING MACHINE LEARNING OF BUSINESS OPERATIONS AND GENERATING RECOMMENDATIONS” and application Ser. No. ______ entitled “SYSTEMS AND METHODS FOR ANALYZING CUSTOMER REVIEWS”, both of which are filed concurrently herewith and the contents of which are incorporated by reference.

### BACKGROUND

Social networks such as Facebook, Twitter, Instagram, and others have brought together millions of people from all over the globe. This social network is a great way to market products or services online and to help them get noticed. Social networks allow companies to not only promote awareness of their products or services but also encourage potential customers and clients to buy them.

For example, Facebook Ads is considered an alternative to Google Ads, YouTube is a go-to site for learning about new products (and how to use them), Instagram offers Shoppable posts, and Reddit users regularly participate in discussion threads about products and brands. Pinterest, position itself as a tool for advertisers interested in providing information to visual buyers.

### SUMMARY

In one aspect, systems and methods are disclosed for automated business intelligence from business data to improve operations of the business.

In another aspect, systems and methods are disclosed to link a product or service to an external content by discovering one or more keywords associated with the product or service; and linking the product or service with the external content from social media.

In yet another aspect, systems and methods are disclosed to automatically associate a product or a service with external content by characterizing the product from unstructured data sources including a product text or text from similar products; generating a label for the product or service; applying the label as a search engine; extracting signals relating to the product or service; and providing business intelligence for the product or service.

The text extraction includes selecting a predetermined number of text identified by TF-IDF (term frequency-inverse document frequency).

The text extraction includes applying an explainability of an attention model to see if the attention model provides one or more keywords or tokens to keep.

The text extraction includes obtaining a primary keyword from a search term and obtaining a secondary keyword from the primary keyword and labeling the product text by word-set-match or by zero-shot learning (ZSL).

The text extraction can also include:
aggregating product titles and descriptions;
identifying n-grams and stopwords from the product titles and descriptions;
extraction by POS of tags to keep predetermined tags; and
determining term frequencies for each product and creating a bag-of-word (BOW).

The method includes representing the product or service as a multimedia file; extracting meta data for the product or service corresponding to the multimedia file; and discovering keywords that connect the image to external signals coming from social media, news articles, or search.

The multimedia file comprises a picture or a video. The external content comprises one or more words in a search term. The method includes extracting signals from a social media site or from a search engine.

The method can link a product or service to an external content by discovering one or more keywords associated with the product or service; and linking the product or service with the external content from social media. The text extraction can include selecting a predetermined number of text identified by TF-IDF (term frequency-inverse document frequency). The text extraction comprises applying an explainability of an attention model to see if the attention model provides one or more keywords or tokens to keep. The text extraction comprises obtaining a primary keyword from a search term and obtaining a secondary keyword from the primary keyword and labeling the product text by word-set-match or by zero-shot learning (ZSL).

In another aspect, a method to generate recommendation includes:
capturing data from one or more business operational data sources;
extracting signals from one or more unstructured data sources;
automatically associating a product or a service with external content by:
characterizing the product from unstructured data sources including a product text or text from similar products;
generating a label for the product or service;
applying the label as a search engine;
extracting signals relating to the product or service;
adding data from a customer review by:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review;

generating one or more metrics from the operational data and unstructured data sources;
identifying one or more anomalies from the metrics; and
suggesting predetermined courses of action and estimated financial impact.

Advantages of the system may include one or more of the following. The system extracts signals from any unstructured data source. The system enables users to understand what customers are thinking by extracting insights from any open-ended text, including chat logs, product reviews, transcripts, and more. The system enables users to perform Data-Driven Merchandising, for example, to answer which product attributes are most likely to surge and underperform in the next season, and why? The system also enables users to identify Marketing ROI and answer questions such as “what are the products and customer segments that would benefit the most from marketing, and what are the right assortments to highlight?” The system enables users to identify the buying process that aligns the voice of the customer with the needs of the enterprise. Customer Experience is improved, and new needs can be anticipated. The system further identifies customer segment churns and how to re-engage customers. The system enables users to perform Dynamic Markdown—which items should be put on clearance? If so, when and by how much? In other uses, the system excels in finding behavioral patterns and early signals of surges and declines, from any data source. Combining signals from text reviews to clickthroughs, among others. The system stitches exhaustive personas and their behavioral shifts, how they are interacting with your offerings, and how this impacts the bottom line. The system can handle large amounts of data and saves users from mining such data to understand what customers are predict trends and capitalize on future demand by finding anomalies and patterns in sales data. The system helps users in knowing which products appear most often across social media (comments, posts, videos, etc.) to stay on top of what's trending. Sales opportunities can be accelerated as the system can predict when customers will interact with brands and turn consumer behavior into sales opportunities and margin improvements. The system helps to optimize customer engagement and maps each customer to the products they actually want to buy and minimize markdowns by engaging them at the times they're most likely to purchase. The system increases revenue through proper inventory allocation and reduces carry-over across product catalog by capitalizing on niche buying and merchandising opportunities. The system improves decision making and identifies demand drivers and improves product development by unifying transaction data with external information about market trends. Bringing together applied machine learning, data science, social science, and managerial science, the system automatically recommends options to reduce the effort required to make higher-quality decisions for users. The system identifies anomalies in customer data and global trends for retail companies that present opportunities and crises to avoid and suggests optimal courses of action and estimated financial impact. The system also alerts individuals with opportunities and predicts customers' needs.

### BRIEF DESCRIPTION OF THE DRAWINGS

FIG. 1 shows an exemplary process for linking a product to external content.

FIG. 2A-2E show exemplary relationships between products expressed as keywords with associated images.

FIGS. 3A-3B show a high-level view of an exemplary system that provides automated business intelligence from business data to improve operations of the business.

### DETAILED DESCRIPTION

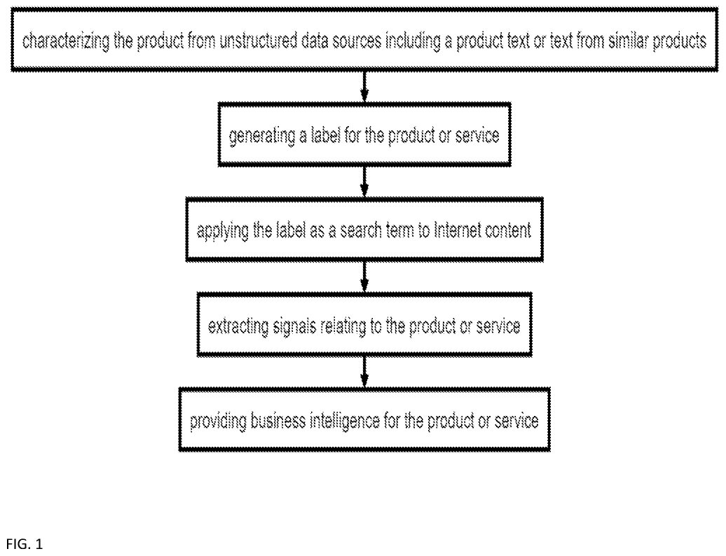

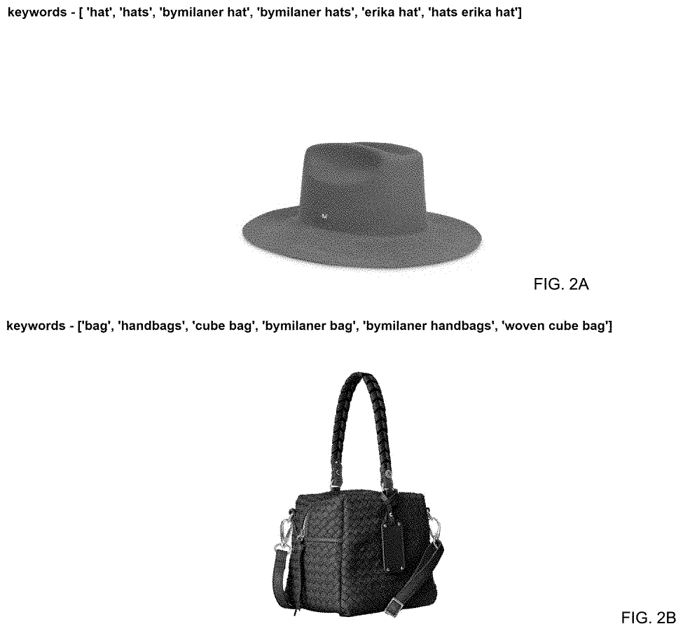

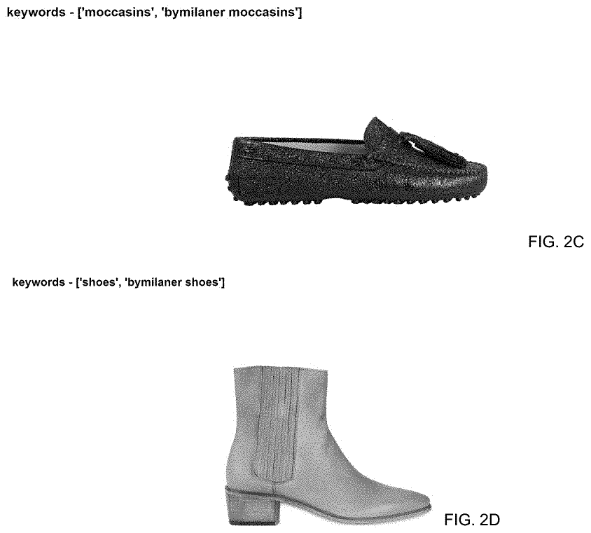

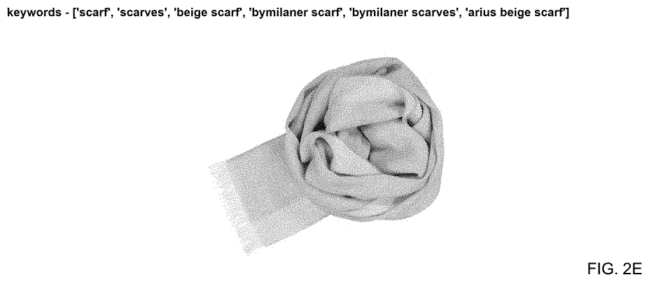

FIG. 1 shows an exemplary process for linking a product to external content while FIG. 2A-2E show exemplary relationships between products expressed as keywords with associated images. The system discovers one or more keywords that connect the image to external signals coming from social media, news articles, and search. Preferably, the signals are words that can be applied to a keyword search tool and/or as search terms on Twitter.

As shown in FIG. 1, the method to automatically associate a product or a service with external content includes:
characterizing the product from unstructured data sources including a product text or text from similar products;
generating a label for the product or service;
applying the label as a search term to Internet content;
extracting signals relating to the product or service; and
providing business intelligence for the product or service.

The system automatically connects a product to external content by identifying keywords. Given meta data for a product, the system discovers keywords that connect the image to external signals coming from social media, news articles, and search. Preferably, the signals are words that can be applied to a keyword search tool and/or as search terms on Twitter.

The system also discovers signals that connect the image to external content by identifying keywords. Given meta data for a product, the system discovers keywords that connect the image to external signals coming from social media, news articles, and search. Preferably, the signals are words that can be applied to a keyword search tool and/or as search terms on Twitter.

The system also discovers signals that connect the image to external content by identifying keywords. Given meta data for a product, the system discovers keywords that connect the image to external signals coming from social media, news articles, and search. Preferably, the signals are words that can be applied to a keyword search tool and/or as search terms on Twitter.

The system also discovers signals that connect the image to external content by identifying keywords. Given meta data for a product, the system discovers keywords that connect the image to external signals coming from social media, news articles, and search. Preferably, the signals are words that can be applied to a keyword search tool and/or as search terms on Twitter.

The system is able to generate a label for the product or service using words that connect the image to external signals coming from social media, news articles, and search. Preferably, the signals are words that can be applied to a keyword search tool and/or as search terms on Twitter.

This is similar to how Google and other search engines operate. They crawl the web and look for keywords in the content and then connect those keywords to pages. In this case, the system is crawling the images on the web and looking for keywords in the image and then connecting those keywords to pages.

The system crawls the web and looks for keywords in the content. For example, if the word “Apple” appears in the text on a page, then the system will connect the word “Apple” to the URL of the page. This connection is called a link.

The system will build a network of links between words and web pages. The system will also crawl the web looking for images and then will build a network of links between words and images.

The system will have a database of millions of products and services. Each product or service will have a unique ID. The system will use the ID to identify the product or service in the image.

If the system finds a match, then it will add the product or service to a list of products and services. If there is no match, then the system will keep looking.

The system creates a word cloud from the text of the meta data. The system compares the word cloud to a database of word clouds of other products, and identifies products that have similar word clouds. The system finds keywords in the meta data that are not in the word cloud, and identifies products with similar words that are not in the word cloud. The system searches the Internet for content related to the product. The system analyzes the content to find words that are related to the product. The system adds the words to the word cloud. The system repeats steps 3-5 until the word cloud is complete.

The system connects the product to external content by identifying keywords. Given meta data for a product, the system discovers keywords that connect the image to external signals coming from social media, news articles, and search. Preferably, the signals are words that can be applied to a keyword search tool and/or as search terms on Twitter.

The system automatically connects a product to external content by identifying keywords. Given meta data for a product, the system discovers keywords that connect the image to external signals coming from social media, news articles, and search. Preferably, the signals are words that can be applied to a keyword search tool and/or as search terms on Twitter.

A system for connecting a product to external content by identifying keywords is disclosed. The system includes a computing device having a processor, memory, and an input device. The system also includes at least one computer readable storage medium having a set of instructions stored thereon that, when executed by the processor, cause the processor to perform a method. The method includes receiving product meta data and a name of the product. The method also includes creating a list of keywords relating to the product. The method further includes matching the product to external content using the list of keywords.

In another embodiment, the product is a product image. In yet another embodiment, the product is a product video. In a further embodiment, the product is a product description. In yet a further embodiment, the product is a product review. In yet another embodiment, the product is a product listing. In a further embodiment, the product is a product advertisement. In yet a further embodiment, the product is a product auction. In yet another embodiment, the product is a product brand. In a further embodiment, the product is a product logo.

The system provides a business intelligence for the product or service in the form of keywords and the external content that the product or service is connected to.

The process begins with the user uploading a picture of the product or service, which is then processed by the system. The system then uses the image as an anchor to gather information from the web using various techniques such as keyword extraction and search term identification. The extracted information is then stored as meta data for the product. The meta data can be used to present the product on external sites such as Facebook, Twitter, Pinterest, etc.

Next, exemplary operations of the system are detailed, where the system automatically connects a product to external content by identifying keywords. Given meta data for a product, the system discovers keywords that connect the product to external signals coming from social media, news articles, and search. Preferably, the signals are words that can be applied to a keyword search tool and/or as search terms on Twitter.

The terms that are used to describe the product or service are called keywords. These keywords can be used in the following ways:
As search terms for the product on Twitter
As search terms for the product on Google
As tags for the product on Pinterest
As tags for the product on Instagram
The keywords can also be used as tags for the product on Facebook.
The keywords can also be used to create a description for the product on a social network site such as Facebook.
The keywords can also be used to create a description for the product on an external website.
The keywords can also be used to create a description for the product on an external mobile application.
The keywords can also be used to create a description for the product on an external device such as a smart watch or a shirt.

The process first extracts texts associated with the product/service. These can come from
1. The product's text
2. The product text of most similar products
3. Defined “labels” that are associated with given products

For (1) and (2), the system gathers the keywords extractively, while for (3), the system generates all labels and then classify each label-product pair as being a match or not. One exemplary product text is as follows:
Product Text={product name, description, category name, variant name}

In one exemplary method to extract text associated with the product/service, the system applies the following steps:
1. The system can use a technique like TF-IDF (term frequency-inverse document frequency) and pick for example the top 10
2. Use TF after removing stop-words and cleaning the data
3. Annotate the keywords manually and train a classifier. Eg. Butterfly Twists
4. Look at the explainability of attention models to see if the attention can provide the keywords/tokens—to select the terms to keep
5. Get primary keywords=from the search terms related to the product (Source: GA)
   1. Get secondary keywords=Get similar words on Keyword Tool or run a snowball algorithm on the product descriptions to get other keywords
   2. Label the Product Text by word-set-match or by ZSL
6. Symbolic NLP=Clean, Stop word removal, and POS tagging
7. Check embeddings with similarity tokens
8. Do PCA with clusters on top and then extract some keywords for each domain and each product

TF-IDF is a statistical measure that evaluates how relevant a word is to a document in a collection of documents. TF works well when there are different categories and the system need to label between them and this is done by multiplying two metrics: how many times a word appears in a document, and the inverse document frequency of the word across a set of documents. Principal component analysis (PCA) is the process of computing the principal components and using them to perform a change of basis on the data, sometimes using only the first few principal components and ignoring the rest.

The system can analyze keywords of other brands for understanding the pattern. For example:
1. Lacoste polo shirt: <meta name=“keywords” content=“Men's Lacoste Regular Fit Crocodile Badge Cotton Piqué Polo Shirt, Polos”>
2. Lacoste sweatshirt: <meta name=“keywords” content=“Men's Sweatshirt Style Cotton T-Shirt, Clothing”>
3. Nike Yoga pants: <meta data-react-helmet=“true” name=“keywords” content=“Nike Yoga Dri-FIT Men's Pants”>
4. Nike Jordan Shoes: <meta data-react-helmet=“true” name=“keywords” content=“Jordan Delta 2 Men's Shoe”>
5. Nike Skate Shoes: <meta data-react-helmet=“true” name=“keywords” content=“Nike SB Bruin React Skate Shoe”>
6. Tesla Model S: <meta name=“keywords” content=“Tesla, Cybertruck, Truck, Utility, Storage”>
7. Tesla Model S: <meta name=“keywords” content=“Tesla, Model S, Model S price, Model S range, Model S 0-60, electric, electric car, electric car range, supercharger, performance, ludicrous speed, highest safety rating, autopilot”>

In yet another embodiment to determine texts associated with the products, the method includes:
1. Extract a TF for each product as follows:
   a. aggregation of all product titles and descriptions
   b. n-grams and stopwords
   c. extraction by POS of relevant tags to keep only those where the system can find value (ex: verbs, noun, . . . )
   d. compute TFs for each product=>giving a BOW with weights for each token
2. For each token of the BOW of each product
   a. query on keywordtool.io to get the popularity level of each token which the system add as a second score
   b. recompute the importance of the tokens by multiplying the TF weight with the score returned by keywordtool.io
3. Extraction of semantic tokens by order of score and addition of features allowing to manage the variants . . . cfr the catalog:product_id/variant_id)

In another embodiment, from prior analysis, the system gathers the keywords using different NLP techniques (TF, TF-IDF, Noun extraction, Product Extraction, among others) for each variant based on the available text from these fields: ‘category_name’, ‘product_name’, ‘variant_name’, ‘product_name_from_url’ and ‘description’

```
  Extraction of Keywords
  Notebook: POC_KeyWords_-Catalog_v5.ipynb
  Data: transformed_Catalog_Merchandise_INNER_MERGED_2021-08-02.parquet
  ============= Record - 2078 =============
  variant_id - 423729
  variant_name - G's jumper skirt
  description - An elegant jumper skirt that looks dressy. It can be used in various
occasions, from casual to dressy. Jersey material that is soft, easy to move around in, and easy to
clean.Added elegant details called inverted pleats on the front and back. Chic color, so it can be
worn when going out as well.
  category_name - Dress (Girls)
  keywords_tf_tfidf_noun - [‘girls jumper’, ‘girls’, ‘jumper’, ‘girls jumper skirt’, ‘jumper
skirt’, ‘skirt’]
  keywords_tf_tfidf_products - [‘girls jumper skirt’, ‘jumper skirt’, ‘skirt’]
  keywords_product_text - [‘skirt’]
  keywords_final - [‘skirt’, ‘jumper skirt’, ‘girls jumper skirt’, ‘kids jumper skirt’]
  ============= Record - 733 =============
  variant_id - 416509
  variant_name - Oval sunglasses
  description - Performance lenses protect eyes from UV rays and blue light. Large oval
frames. Special AR coating prevents excess glare on lenses. Made of light, durable material with
an elegant feel. Large frame size. Available in a range of basic colors.Reduction of blue light by
15%, reducing eye fatigue from PCs and smartphones.With UV400 lenses that cut UV rays by
99%.
  category_name - Sunglasses
  keywords_tf_tfidf_noun - [‘oval’, ‘sunglasses’, ‘uv’, ‘sunglasses oval sunglasses’, ‘lenses’,
‘oval sunglasses’]
  keywords_tf_tfidf_products - [‘oval sunglasses’, ‘sunglasses oval sunglasses’,
‘sunglasses’, ‘uv’]
  keywords_product_text - [‘sunglasses’]
  keywords_final - [‘sunglasses’, ‘uv’, ‘oval sunglasses’, ‘men oval sunglasses’,
‘sunglasses oval sunglasses’]
  ============= Record - 4726 =============
  variant_id - 434335
  variant_name - BT cropped leggings (lemon)
  description - Sleek cropped length for cool comfort. Versatile colors and patterns for
every day wear.Adjustable elastic waistband. The waistband is secured on the right side to
prevent twisting.Colors and patterns that will add a cute touch to any outfit.
  category_name - Leggings Pants (Baby)
  keywords_tf_tfidf_noun - [‘cropped leggings’, ‘leggings’, ‘patterns’, ‘baby’, ‘baby cropped
leggings’]
  keywords_tf_tfidf_products - [‘baby cropped leggings’, ‘cropped leggings’, ‘leggings’]
  keywords_product_text - [‘leggings’]
  keywords_final - [‘leggings’, ‘cropped leggings’, ‘baby cropped leggings’]
  ============= Record - 4982 =============
  variant_id - 435791
  variant_name - (+J) merino blend V neck L/S cardigan
  description - Legendary designer Jil Sander returns to with her signature modernist
style. Inspired by a sense of enlightened understatement, the collection consists of exceptional
pieces with versatile styling options.Elegant merino wool with added stretch for ultimate beauty
and comfort.Extra-fine, 18.5-micron merino wool with nylon for stretch. Soft and smooth with a
defined texture and beautiful luster. Densely knit yet comfortable. Simple design that goes well
with any style.
  category_name - Merino (Men)
  keywords_tf_tfidf_noun - [‘cardigan’, ‘merino’, ‘blend’, ‘blend neck’, ‘neck’, ‘merino
blend’, ‘merino blend neck’]
  keywords_tf_tfidf_products - [‘merino’, ‘cardigan’]
  keywords_product_text - [‘merino’, ‘cardigan’]
  keywords_final - [‘cardigan’, ‘merino’, ‘blend cardigan’, ‘blend merino’, ‘men
blend cardigan’, ‘men blend merino’, ‘blend neck merino’, ‘blend neck cardigan’, ‘men
blend neck merino’, ‘men blend neck cardigan’]
```

In yet another implementation, the process includes:
1. Create a new column product_name_from_url by extracting the name of the product from the column image_link.
2. Create a new column text=category_name+product_name+variant_name+product_from_url+description
3. Create a new column preprocess_text by preprocessing the text column (lowercase letters+removing non-alpha characters+removing stopwords)
4. Create a new column tf_terms from processing_text column by performing (1-3)-grams and TF (term frequency) in order to compute a score for each group of words to signify its importance in the document. Then the system get the top 5 most important words
5. Create a new column tfidf_terms from precessing_text column by performing (1-3)-grams and TFIDF (Term frequency-Inverse Document Frequency) in order to compute a score for each group of words to signify its importance in the document and corpus. Then the system get the top 5 most important words.
6. Create a new column keywords_tf_tfidf_noun from tf_terms and tfidf_terms column by keeping only terms where the last token is a noun.
7. Create a new column keywords_tf_tfidf_product from tf_terms and tfidf_terms column by keeping only terms where the last token is a noun and is in the list of products.
8. Create a new column keywords_product_text from product_from_url column by extracting words that are in all_products_list.
9. Create a new column keywords which is the combination of the column ‘keywords_tf_tfidf_products’ and ‘keywords_product_text’
10. Create a new column product_list from tf_terms, keywords_tf_tfidf_products, ‘keywords_tf_tfidf_noun and keywords_product_text column by extracting words that are in all_products_list.
11. Create a new column terms_list from keywords_tf_tfidf_noun by keeping terms that have more than 1 token.
12. Create a new column keywords_inital from terms_list and product_list by adding the product name to each term. Do nothing if product_list is empty
13. Create a new column keywords_combined by aggregating the terms in the columns keywords_tf_tfidf_products, product_list and keywords_product_text.
14. Create a new column keyword_final=keywords_combined if not empty else keywords_tf_tfidf_noun. Then the system sorts the keywords by the number of tokens in ascending order

Next, examples on each step are provided to illustrate the operation.

Record - 0
variant_id - BORSA SHOPPING LUX B nero
cost - 420.0
description -
product_id - 2420621639738
category_id - Woven Handbags
variant_name - Black
product_name - AMLveda_Test
category_name - Woven Handbags
original_price - 420.0
image_link ( -
https://cdn.shopify.com/s/files/1/1048/0440/products/anna_black_fron
t_1920x_copy_9d29dee6-9220-4f07-9c73-fe2e88478c71.jpg?v=1566270221 -
status - archived
original_product_id - 2420621639738

1. Create a new column product_name_from_url by extracting the name of the product from the column image_link.

```
Input :
  - https://cdn.shopify.com/s/files/1/1048/0440/products/anna_black_front_19
20x_copy_9d29dee6-9220-4f07-9c73-fe2e88478c71.jpg?v=1566270221
Output :
  - ‘anna black front copy’
```

2. Create a new column text=category_name+product_name+variant_name+product_from_url+description

```
Input :
  Woven Handbags (category_name)
  - m (product_name)
  - Black (variant_name)
  - anna black front copy (product_from_url)
  - “” (description)
Output:
  - ′Woven Handbags AMLveda_Test Black anna black front copy′
```

3. Create a new column preprocess_text by preprocessing the text column (lowercase letters+removing non-alpha characters+removing stopwords)

```
Input :
  - ′Woven Handbags AMLveda_Test Black anna black front copy′
Output :
  - ′woven handbags amlveda test black anna black copy′
PS : “front” was removed in the output because it is a stopword.
```

4. Create a new column tf_terms from precessing_text column by performing (1-3)-grams and TF (Term frequency) in order to compute a score for each group of words to signify its importance in the document. Then the system get the top 5 most important words.

```
Input :
  - ′woven handbags amlveda test black anna black copy′
Output ((1-3)-grams) :
  - [′woven’, ‘handbags’, ‘amlveda’, ‘test’, ‘black’, ‘anna’, ‘black’,
  ‘copy’, ′woven handbags’,’handbags amlveda’,‘amlveda test’, ‘test
black’,‘black anna’, ‘anna black’,‘black copy’,
  ′woven handbags amlveda’, handbags amlveda test’, ‘amlveda test
black’, ‘test black anna’, ‘black anna black’, ‘anna black copy’ ]
Output (TF top5) :
  - [′black′, ′anna black′, ′black copy′, ′copy′, ′test black anna′]
```

5. Create a new column tfidf_terms from precessing_text column by performing (1-3)-grams and TFIDF (Term frequency-Inverse Document Frequency) in order to compute a score for each group of words to signify its importance in the document and corpus. Then the system get the top 5 most important words.

```
Input :
  - ‘woven handbags amlveda test black anna black copy’
Output (TF-IDF top5) :
  - [‘test black anna’,‘test black’, ‘amlveda test black’, ‘black anna’,
‘black anna black’]
```

6. Create a new column keywords_tf_tfidf_noun from tf_terms and tfidf_terms column by keeping only terms where the last token is a noun.

```
Input :
  - [‘black’, ‘anna black’, ‘black copy’, ‘copy’, ‘test black anna’]
  - [‘test black anna’,‘test black’, ‘amlveda test black’, ‘black anna’,
‘black anna black’]
Output :
  - [black copy]
```

7. Create a new column keywords_tf_tfidf_product from tf_terms and tfidf_terms column by keeping only terms where the last token is a noun and is in the list of products.

```
Input :
  - [‘black’, ‘anna black’, ‘black copy’, ‘copy’, ‘test black anna’]
  - [‘test black anna’,‘test black’, ‘amlveda test black’, ‘black anna’,
‘black anna black’]
  - ‘jacket card accessories accessory moccasins scarves shoe handbag
monogram gift scarf moccasin jewelry shoes hats wallet winter cards hat
handbags leather’
  ( product_string )
Output :
  - [ ]
```

8. Create a new column keywords_product_text from product_from_url column by extracting words that are in all_products_list.

```
Input :
  - ‘anna black front copy’
  - [′jacket′,′card′,′accessories′, ′accessory′, ′moccasins′, ′scarves′, ′shoe′,
′handbag′, ′monogram′, ′gift′, ′scarf′, ′moccasin′, ′jewelry′, ′hats′, ′shoes′,
′wallet′, ′winter′, ′cards′, ′hat′, ′handbags′, ′leather′] ( all_products_list )
Output :
  - [ ]
```

9. Create a new column keywords which is the combination of the column ‘keywords_tf_tfidf_products’ and ‘keywords_product_text’

```
Input :
  - [ ] ( ′keywords_tf_tfidf_products′ )
  - [ ] ( ‘keywords_product_text′ )
Output :
  - [ ]
```

10. Create a new column product_list from tf_terms, keywords_tf_tfidf_products, ‘keywords_tf_tfidf_noun and keywords_product_text column by extracting words that are in all_products_list.

```
Input :
  - [′black′, ′anna black′, ′black copy′, ′copy′, ′test black anna′] (tf_terms)
  - [black copy] ( ′keywords_tf_tfidf_noun’ )
  - [ ] ( ′keywords_tf_tfidf_products′ )
  - [ ] ( ‘keywords_product_text′ )
Output :
  - [ ]
```

11. Create a new column terms_list from keywords_tf_tfidf_noun by keeping terms that have more than 1 token.

```
Input :
  - [black copy] ( ′keywords_tf_tfidf_noun’ )
Output :
  - [black copy]
```

12. Create a new column keywords_inital from terms_list and product_list by adding the product name to each term. Do nothing if product_list is empty

```
Input :
  - [black copy] ( terms_list )
  - [ ] ( product list )
Output :
  - [ ]
```

13. Create a new column keywords_combined by aggregating the terms in the columns keywords_tf_tfidf_products, product_list and keywords_product_text.

```
Input :
  - [ ] ( ′keywords_tf_tfidf_products′ )
  - [ ] ( ‘keywords_product_text′ )
  - [ ] ( product list )
Output :
  - [ ]
```

14. Create a new column keyword_final=keywords_combined if not empty else keywords_tf_tfidf_noun. Then the system sort the keywords by the number of tokens in ascending order.

```
  Input :
    - [ ] ( keywords_combined )
    - [black copy] ( keywords_tf_tfidf_noun )
  Output :
    - [black copy]
  Summary :
  ============Record - 0================
  variant_id - BORSA SHOPPING LUX B nero
  cost - 420.0
  description -
  product_id - 2420621639738
  category_id - Woven Handbags
  variant_name - Black
  product_name - AMLveda _Test
  category_name - Woven Handbags
  original_price - 420.0
  image_link -
https://cdn.shopify.com/s/files/1/1048/0440/products/anna_black_front_1920x_copy_9d29dee6-
9220-4f07-9c73-fe2e88478c71.jpg?v=1566270221 -
  status - archived
  original_product_id - 2420621639738
  product_from_url - anna black front copy
  text - Woven Handbags AMLveda_Test Black anna black front copy
  preprocessed_tex - woven handbags amlveda test black anna black copy
  tf_terms - [‘black’, ‘anna black’, ‘black copy’, ‘copy’, ‘test black anna’]
  tfidf_terms - I‘test black anna’, test black’, ‘amlveda test black’, ‘black anna’, ‘black anna
black’]
  keywords_tf_tfidf_noun - [‘black copy’]
  keywords_tf_tfidf_products - [ ]
  keywords_product_text - - [ ]
  keywords - [ ]
  product_list - [ ]
  terms_list - [‘black copy’1
  keywords_initial - [ ]
  keywords_combined - [ ]
  keywords_final - [‘black copy’]
```

In another embodiment (ByMilaner Keywords v2), the system makes the following update to the model:

```
      ○ Include product information in the available text + text_from_url
      ○ Use top 10 tf and tf-idf terms for the extraction instead of top 5
    terms.
      ○ Use of brand_name (_bymilaner_) included as part of extracted
    keywords
  ============= Record - 121 =============
  variant_id - ARIA HEELED SANDAL _ POWDER _ 10
  product_id - 2482406424634
  category_id - Shoes
  variant_name - Powder / 10
  product_name - The Aria Woven Heeled Sandal
  category_name - Shoes
  image_link -
  keywords_final - [‘shoes’, ‘bymilaner shoes’]
  ============= Record - 930 =============
  variant_id - SIMONE SANDAL _ VACHETTA _ 8
  product_id - 2465135329338
  category_id - Shoes
  variant_name - Vachetta / 8
  product_name - The Simone Woven Sandal
  category_name - Shoes
  image_link -
  keywords_final - [‘shoes’, ‘bymilaner shoes’]
  ============= Record - 1058 =============
  variant_id - TRAVEL ELENA _ BLACK _ nappa
  product _id - TRAVEL ELENA _ BLACK _ nappa
  category_id - Handbags
  variant_name - Black Nappa
  product_name - The Travel Elena Woven Handbag (Black Nappa)
  category_name - Handbags
  image_link -
  keywords_final - [‘handbag’, ‘handbags’, ‘bymilaner handbag’, ‘bymilaner
handbags’, ‘elena woven handbag’]
  ============= Record - 1071 =============
  variant_id - MYP 068
  product_id - 4322025930810
  category_id - Scarves
  variant_name - Grey
  product_name - The Two-Colored Scarf
  category_name - Scarves
  image_link -
  keywords_final - [‘scarf’, ‘scarves’, ‘bymilaner scarf’, ‘bymilaner scarves’, ‘colored
scarf’, ‘two colored scarf’]
```

In another embodiment with Adwords, the system can use all the keywords (˜10,000) from the above analysis to gauge the weightage based on the Google Ads metrics for them: search_volume, cost-per-click and competition. Also, ranked these Adwords based on their relative importance with respect to Google Ads metrics.

Sample Keywords/Adwords:
Df_uniqlo_keywords_export[[‘variant_id’, ‘description’,
‘variant_name’, ‘category_name’, ‘product_name’,
‘keywords_final’, ‘adwords_detail’, ‘adwords’]].sample(S)

| | variant_id | description | variant_name | category_name | product_name | keywords_final | adwords_detail | adwords |
|---|---|---|---|---|---|---|---|---|
| 4543 | 433400 | Smooth, | AIRism | UV Cut | MEN AIRism | [‘tights’, | [{‘keyword’: | [‘tights’, |
| | | supportive | UV | (Men) | PERFORMANCE | ‘airism’, | ‘tights’, | ‘airism’] |
| | | tights. UPF50+ | protection | | SUPPORT | ‘performance | ‘search_volume’: | |
| | | Uses AIRism | performance | | TIGHTSÿ | tights’, | 135000, | |
| | | material. | support | | | ‘performance | ‘cpc’: | |
| | | Prevents | tights | | | airism’, | 0.939514, | |
| | | fatigue thanks | | | | ‘performance | ‘competition’: | |
| | | to high-level | | | | support | 0.997346834, | |
| | | support. | | | | airism’, | ‘rank’: 0.9399}, | |
| | | | | | | ‘men | {‘keyword’: | |
| | | | | | | performance | ‘airism’, | |
| | | | | | | airism’, | ‘search_volume’: | |
| | | | | | | ‘men | 1900, ‘cpc’: | |
| | | | | | | performance | 0.380916, | |
| | | | | | | tights’, | ‘competition’: | |
| | | | | | | ‘performance | 0.999495714, | |
| | | | | | | support | ‘rank’: 0.7402}, | |
| | | | | | | tights’, | {‘keyword’: | |
| | | | | | | ‘men | ‘performance | |
| | | | | | | performance | tights’, | |
| | | | | | | support | ‘search_volume’: | |
| | | | | | | tights’, | 90, ‘cpc’: | |
| | | | | | | ‘men | 0.908658, | |
| | | | | | | performance | ‘competition’: | |
| | | | | | | support | 1.0, ‘rank’: | |
| | | | | | | airism’] | 0.2459}] | |
| 573 | 418437 | Elegant fabric | W's | Bottoms | WOMEN | [‘pants’, | [{‘keyword’: | [‘pants’, |
| | | and leg- | HEATTECH | (Women) | WIDE- | ‘leggings’, | ‘pants’, | ‘leggings’, |
| | | lengthening | ponte | | RIBBED | ‘ponte | ‘search_volume’: | ‘ponte |
| | | silhouette | leggings | | SLIT | leggings’, | 1830000, | leggings’, |
| | | create a | pants | | STRAIGHT | ‘heattech | ‘cpc’: | ‘women |
| | | fashionable | | | PANTS | ponte | 1.090578, | ponte |
| | | style. | | | | pants’, | ‘competition’: | leggings’] |
| | | HEATTECH | | | | ‘ponte | 0.999926568, | |
| | | lining keeps | | | | leggings | ‘rank’: 0.993}, | |
| | | you | | | | pants’, | {‘keyword’: | |
| | | warm. Ponte | | | | ‘women | ‘leggings’, | |
| | | fabric is | | | | ponte | ‘search_volume’: | |
| | | smooth and | | | | leggings’, | 1220000, | |
| | | elegant and | | | | ‘heattech | ‘cpc’: | |
| | | stretches for | | | | ponte | 2.141965, | |
| | | easy | | | | leggings’, | ‘competition’: | |
| | | movement. | | | | ‘women | 0.99994797, | |
| | | Lined with a | | | | heattech | ‘rank’: 0.9795}, | |
| | | soft, brushed | | | | ponte | {‘keyword’: | |
| | | HEATTECH | | | | pants’, | ‘ponte | |
| | | material that | | | | ‘women | leggings’, | |
| | | feels warm | | | | ponte | ‘search_volume’: | |
| | | from the | | | | leggings | 2900, ‘cpc’: | |
| | | moment you | | | | pants’, | 1.607404, | |
| | | put them on. | | | | ‘women | ‘competition’: | |
| | | Center seams | | | | heattech | 1.0, ‘rank’: | |
| | | with defined | | | | ponte | 0.6288}, | |
| | | crease | | | | leggings’] | {‘keyword’: | |
| | | emphasize the | | | | | ‘women ponte | |
| | | vertical line, | | | | | leggings’, | |
| | | making your | | | | | ‘search_volume’: | |
| | | legs look | | | | | 590, ‘cpc’: | |
| | | slender and | | | | | 1.678769, | |
| | | long. Elastic | | | | | ‘competition’: | |
| | | waist for | | | | | 1.0, ‘rank’: | |
| | | comfort. Full- | | | | | 0.3964}, | |
| | | length style | | | | | {‘keyword’: | |
| | | provides | | | | | ‘ponte leggings | |
| | | complete cold | | | | | pants’, | |
| | | protection | | | | | ‘search_volume’: | |
| | | down to your | | | | | 40, ‘cpc’: | |
| | | ankles. | | | | | 1.186185, | |
| | | | | | | | ‘competition’: | |
| | | | | | | | 1.0, ‘rank’: | |
| | | | | | | | 0.1423}] | |
| 5982 | 437266 | UT | Eco- | 36-34: Bag | MEDIUM | [‘bag’] | [{‘keyword’: | [‘bag’] |
| | | GOODSWith | friendly | | ECO- | | ‘bag’, | |
| | | UT goods, you | printed | | FRIENDLY | | ‘search_volume’: | |
| | | can enjoy | bag | | PRINTED | | 301000, | |
| | | artwork and | M(Lifewear | | TOTE BAG | | ‘cpc’: | |
| | | motifs from | B) | | (ROY | | 1.190561, | |
| | | our | | | LICHTENSTEIN) | | ‘competition’: | |
| | | collaborations | | | | | 0.999652996, | |
| | | with big-name | | | | | ‘rank’: 0.9591}] | |
| | | artists such as | | | | | | |
| | | Keith Haring | | | | | | |
| | | and Billie | | | | | | |
| | | Eilish through | | | | | | |
| | | items like | | | | | | |
| | | notebooks, | | | | | | |
| | | stickers, | | | | | | |
| | | bandanas, | | | | | | |
| | | and more. | | | | | | |
| | | Adding a | | | | | | |
| | | stylish, artistic | | | | | | |
| | | kick to | | | | | | |
| | | everyday | | | | | | |
| | | goods! | | | | | | |
| 3716 | 429681 | This dobby | W's HPJ | Solid | WOMEN | [‘shirt’, | [{‘keyword’: | [‘shirt’, |
| | | shirt has a | cotton | Casual | COTTON | ‘cotton’, | ‘shirt’, | ‘cotton’, |
| | | nice texture. | dobby half | Shirts | DOBBY | ‘dobby | ‘search_volume’: | ‘dobby |
| | | Looks great | slv shirt | (Women) | HALF- | cotton’, | 450000, | cotton’] |
| | | tucked in or | | | SLEEVE | ‘dobby half | ‘cpc’: 1.35088, | |
| | | worn out. | | | SHIRT | cotton’, | ‘competition’: | |
| | | From our | | | (HANA | ‘hana | 0.99997438166659, | |
| | | collaboration | | | TAJIMA) | tajima | ‘rank’: | |
| | | with fashion | | | | cotton’, | 0.9643}, | |
| | | designer Hana | | | | ‘women | {‘keyword’: | |
| | | Tajima. Can | | | | dobby | ‘cotton’, | |
| | | be worn as a | | | | cotton’, | ‘search_volume’: | |
| | | light jacket or | | | | ‘dobby half | 90500, | |
| | | tucked in on | | | | sleeve | ‘cpc’: 1.57539, | |
| | | one side of the | | | | cotton’, | ‘competition’: | |
| | | hem. | | | | ‘women | 0.906198001, | |
| | | | | | | hana | ‘rank’: 0.8908}, | |
| | | | | | | tajima | {‘keyword’: | |
| | | | | | | cotton’, | ‘dobby cotton’, | |
| | | | | | | ‘women | ‘search_volume’: | |
| | | | | | | dobby half | 210, ‘cpc’: | |
| | | | | | | cotton’, | 1.343667, | |
| | | | | | | ‘women | ‘competition’: | |
| | | | | | | dobby half | 1.0, ‘rank’: | |
| | | | | | | sleeve | 0.2946}] | |
| | | | | | | cotton’] | | |
| 3537 | 428914 | PEANUTS | W's | Home | WOMEN | [‘fleece’, | [{‘keyword’: | [‘fleece’] |
| | | HOLIDAY | PEANUTS | (Women) | PEANUTS | ‘peanuts | ‘fleece’, | |
| | | COLLECTION | HOLIDAY | | HOLIDAY | holiday | ‘search_volume’: | |
| | | A collection of | fleece | | COLLECTION | fleece’, | 74000, | |
| | | loungewear | room | | FLEECE | ‘women | ‘cpc’: | |
| | | for the holiday | shoes | | SLIPPERS | peanuts | 1.071012, | |
| | | season, with | | | (ONLINE | holiday | ‘competition’: | |
| | | designs | | | EXCLUSIVE) | fleece’, | 0.997640682, | |
| | | featuring | | | | ‘collection | ‘rank’: 0.9043}] | |
| | | Snoopy, | | | | fleece | | |
| | | Woodstock | | | | slippers | | |
| | | and Charlie | | | | fleece’, | | |
| | | Brown. Enjoy | | | | ‘women | | |
| | | time spent at | | | | collection | | |
| | | home with | | | | fleece | | |
| | | family and | | | | slippers | | |
| | | loved ones | | | | fleece’] | | |
| | | while wearing | | | | | | |
| | | these | | | | | | |
| | | delightful, | | | | | | |
| | | newly added | | | | | | |
| | | items.&copy; | | | | | | |
| | | 2020 Peanuts | | | | | | |
| | | Worldwide | | | | | | |
| | | LLC | | | | | | |

In yet another implementation:

ByMilaner Keywords v1

| | |
|---|---|
| • | To extract the Keywords for ByMilaner, the system have used the same |

model the system developed for (with some minor tweaks). The data the system used for
this extraction is an inner merge of bymilaner_catelog_data and
bymilaner_merchandise_data.

| | |
|---|---|
| • | Below are the data fields available for ByMilaner: |
| | ○ [′variant_id′, ′cost′, ′description′, ′product_id′, ′category_id′, |

```
  ′variant_name′, ′product_name′, ′category_name′, ′original_price′, ′image_link′,
  ′status′, ′original_product_id′]
```

| | |
|---|---|
| • | Below are the available text fields for ByMilaner: |
| | ○ [′category_name′, ′product_name′, ′variant_name′] |
| • | There is no data in the ‘description’ field for Bymilaner. |
| • | Bymilaner company is into Handbags, Shoes, Accessories and Hats |

categories only.

| | |
|---|---|
| • | Currently, the ByMilaner website does not have any keywords for their |

products.
============= Record - 121 =============
variant_id - ARIA HEELED SANDAL _ POWDER _ 10
cost - 450.0
description -
product_id - 2482406424634
category_id - Shoes
variant_name - Powder / 10
product_name - The Aria Woven Heeled Sandal
category_name - Shoes
original_price - 450.0
image _link -
status - archived
original_product_id - 2482406424634
product_from_url - woven heeled sandal beige side
keywords_final - [′sandal′, ′heeled sandal′, ′woven heeled sandal′]
============= Record - 1071 =============
variant_id - MYP 068
cost - 110.0
description -
product_id - 4322025930810
category_id - Scarves
variant_name - Grey
product_name - The Two-Colored Scarf
category_name - Scarves
original_price - 110.0
image_link -
status - archived
original_product_id - 4322025930810
product_from_url - milaner morbida
keywords_final - [′scarves′, ′scarf′, ′two colored scarf′]
============= Record - 930 =============
variant_id - SIMONE SANDAL _ VACHETTA _ 8
cost - 235.0
description -
product_id - 2465135329338
category_id - Shoes
variant_name - Vachetta / 8
product_name - The Simone Woven Sandal
category_name - Shoes
original_price - 235.0
image_link -
status - active
original_product_id - 2465135329338
product_from_url -
keywords_final - [′shoes′]
============= Record - 1058 =============
variant_id - TRAVEL ELENA _ BLACK _ nappa
cost - 545.0
description -
product_id - TRAVEL ELENA _ BLACK _ nappa
category_id - Handbags
variant_name - Black Nappa
product_name - The Travel Elena Woven Handbag (Black Nappa)
category_name - Handbags
original_price - 545.0
image_link -
status - active
original_product_id - 2343925153850
product_from_url - tote
keywords_final - [′handbag′, ′elena woven handbag′]
============= Record - 574 =============
variant_id - RR-M0028 0405-S17 OFFWHITE
cost - 290.0
description -
product_id - 2384065626170
category_id - Mara and Ronny Marziali
variant_name - Ivory / S
product_name - The Knotted Open Back Sweater
category_name - Mara and Ronny Marziali
original_price - 290.0
image_link -
status - archived
original_product_id - 2384065626170
product_from_url -
keywords_final - [′ivory′, ′sweater′, ′open sweater′, ′knotted open sweater′]
============= Record - 231 =============
variant_id - capeline cream - cream
description -
product_id - 611461365818
category_id - Hats
variant_name - Cream / Cream
product_name - The Capeline
category_name - Hats
image_link -
original_product_id - 611461365818
product_from_url -
keywords_final - [′hats′]

Keywords with Images

Pseudo Code (Keywords Extraction—v1):

Let us use an example to illustrate the different steps of the pseudo code:

Record - 1058
variant id - TRAVEL ELENA BLACK nappa
cost - 545.0
description -
product_id - TRAVEL ELENA BLACK nappa
category_id - Handbags
variant_name - Black Nappa
product_name - The Travel Elena Woven Handbag (Black Nappa)
category_name - Handbags
original_price - 545.0
image_link -
https://cdn.shopify..com/s/files/1/1048/0440/products/TOTE_1.jpg?v=1621105
903 -
status - active
original_product_id - 2343925153850

1. Create a new column product_name_from_url by extracting the name of the product from the column image_link.

```
Input :
  - image file of a product
Output :
  - ‘tote’
```

2. Create a new column text=category_name+product_name+variant_name+product_from_url+description

```
Input :
  Handbags (category_name)
  - The Travel Elena Woven Handbag (Black Nappa) (product_name)
  - Black Nappa (variant_name)
  - tote (product_from_url)
  - “” (description)
Output :
  - ′Handbags The Travel Elena Woven Handbag (Black Nappa) Black
Nappa tote′
```

3. Create a new column preprocess_text by preprocessing the text column (lowercase letters+removing non-alpha characters+removing stopwords)

```
Input :
  - ‘Handbags The Travel Elena Woven Handbag (Black Nappa) Black
Nappa tote’
Output :
  - ‘handbags travel elena woven handbag black nappa black nappa tote’
```

Here, “The” was removed in the output because it is a stopword.
4. Create a new column tf_terms from precessing_text column by performing (1-3)-grams and TF (Term frequency) in order to compute a score for each group of words to signify its importance in the document. Then the system get the top 5 most important words.

```
Input :
  - ‘handbags travel elena woven handbag black nappa black nappa tote’
Output (TF top 5) :
  - [‘nappa’, ‘black nappa’, ‘black’, ‘tote’, ‘elena woven handbag’]
```

5. Create a new column tfidf_terms from precessing_text column by performing (1-3)-grams and TFIDF (Term frequency-Inverse Document Frequency) in order to compute a score for each group of words to signify its importance in the document and corpus. Then the system get the top 5 most important words.

```
Input :
  - ‘handbags travel elena woven handbag black nappa black nappa tote’
Output (TF-IDF top 5) :
  - [‘black nappa’, ‘nappa’, ‘nappa black nappa’, ‘black nappa tote’,
‘black nappa black’]
```

6. Create a new column keywords_tf_tfidf_noun from tf_terms and tfidf_terms column by keeping only terms where the last token is a noun.

```
Input :
  - [‘nappa’, ‘black nappa’, ‘black’, ‘tote’, ‘elena woven handbag’]
  - [‘black nappa’, ‘nappa’, ‘nappa black nappa’, ‘black nappa tote’,
‘black nappa black’]
Output :
  - [‘elena woven handbag’, ‘black nappa black’, ‘black nappa’,
‘nappa’, ‘black nappa tote’, ‘nappa black nappa’]
```

7. Create a new column keywords_tf_tfidf_product from tf_terms and tfidf_terms column by keeping only terms where the last token is a noun and is in the list of products.

```
Input :
  - [‘nappa’, ‘black nappa’, ‘black’, ‘tote’, ‘elena woven handbag’]
  - [‘black nappa’, ‘nappa’, ‘nappa black nappa’, ‘black nappa tote’,
‘black nappa black’]
  - ‘jacket card accessories accessory moccasins scarves shoe handbag
monogram gift scarf moccasin jewelry shoes hats wallet winter cards hat
handbags leather’
  ( product_string )
Output :
  - [‘elena woven handbag’]
```

8. Create a new column keywords_product_text from product_from_url column by extracting words that are in all_products_list.

```
Input :
  - ‘tote’
  - [′jacket′,′card′,′accessories′, ′accessory′, ′moccasins′, ′scarves′, ′shoe′,
′handbag′, ′monogram′, ′gift′, ′scarf′, ′moccasin′, ′jewelry′, ′hats′, ′shoes′,
′wallet′, ′winter′, ′cards′, ′hat′, ′handbags′, ′leather′] ( all_products_list )
Output :
  - [ ]
```

9. Create a new column keywords which is the combination of the column ‘keywords_tf_tfidf_products’ and ‘keywords_product_text’

```
Input :
  - [′elena woven handbag′] ( ′keywords_tf_tfidf_products′ )
  - [ ] ( ‘keywords_product_text′ )
Output :
  - [′elena woven handbag′]
```

10. Create a new column product_list from tf_terms, keywords_tf_tfidf_products, ‘keywords_tf_tfidf_noun and keywords_product_text column by extracting words that are in all_products_list.

```
Input :
  - [′nappa′, ′black nappa′, ′black′, ′tote′, ′elena woven handbag′]
(tf_terms)
  - [′elena woven handbag′, ′black nappa black′, ′black nappa′, ′nappa′,
′black nappa tote′, ′nappa black nappa′] ( ′keywords_tf_tfidf_noun’ )
  - [ ′elena woven handbag’] ( ′keywords_tf_tfidf_products′ )
  - [ ] ( ‘keywords_product_text′ )
Output :
  - [′handbag′ ]
```

11. Create a new column terms_list from keywords_tf_tfidf_noun by keeping terms that have more than 1 token.

```
Input :
  - [′elena woven handbag′, ′black nappa black′, ′black nappa′, ′nappa′,
′black nappa tote′, ′nappa black nappa′] ( ′keywords_tf_tfidf_noun’ )
Output :
  - [′elena woven handbag′, ′black nappa black′, ′black nappa′, ′black
nappa tote′, ′nappa black nappa′]
```

12. Create a new column keywords_inital from terms_list and product_list by adding the product name to each term. Do nothing if product_list is empty

```
Input :
  - [‘elena woven handbag’, ‘black nappa black’, ‘black nappa’, ‘black
nappa tote’, ‘nappa black nappa’] ( terms_list )
  - [‘handbag’ ] ( product list )
Output :
  - [‘elena woven handbag’, ‘nappa black nappa handbag’, ‘black nappa
handbag’, ‘black nappa tote handbag’, ‘black nappa black handbag’]
```

13. Create a new column keywords_combined by aggregating the terms in the columns keywords_tf_tfidf_products, product_list and keywords_product_text.

```
Input :
  - [′elena woven handbag′] ( ′keywords_tf_tfidf_products′ )
  - [ ] ( ‘keywords_product_text′ )
  - [‘handbag’ ] ( product list )
Output :
  - [′handbag′, ′elena woven handbag′]
```

14. Create a new column keyword_final=keywords_combined if not empty else keywords_tf_tfidf_noun. Then the system sort the keywords by the number of tokens in ascending order.

```
  Input :
    - [‘handbag’, ‘elena woven handbag’] ( keywords_combined )
    - [‘elena woven handbag’, ‘black nappa black’, ‘black nappa’, ‘nappa’, ‘black
  nappa tote’, ‘nappa black nappa’] ( keywords_tf_tfidf_noun )
  Output :
    - [‘handbag’, ‘elena woven handbag’]
  Summary :
    Record - 1058
  variant id - TRAVEL ELENA BLACK nappa
  cost - 545.0
  description
  product_id - TRAVEL ELENA BLACK nappa
  category_ic - Handbags
  variant_name - Black Nappa
  product_name - The Travel Elena Woven Handbag (Black Nappa)
  category_name - Handbags
  original_price - 545.0
  image_link -
https://cdn.shopify.com/s/files/1/1048/0440/products/TOTE_1.jpg?v=1621105903
  status - active
  briginal_product_id - 2343925153850
  product_from_url - tote
  text - Handbags The Travel Elena Woven Handbag (Black Nappa) Black Nappa tote
  preprocessed_text - handbags travel elena woven handbag black nappa black nappa tote
  -
  tf_terms - [‘nappa’, ‘black nappa’, ‘black’, ‘tote’, ‘elena woven handbag’]
  tfidf_terms - [ black nappa’, ‘nappa’, ‘nappa black nappa’, ‘black nappa tote’, ‘black nappa
black’ ]
  keywords_tf_tfidf_noun - [ ‘elena woven handbag’, ‘black nappa black’, ‘black nappa’,
‘nappa’, ‘black nappa tote’, ‘nappa b
  lack nappa’]
  keywords_tf_tfidf_products - [ elena woven handbag’]
  keywords_product_text - [ ]
  keywords - [‘elena woven handbag’ - ]
  product_list - [ ‘handbag’]
  terms_list - ‘elena woven handbag’ ‘black nappa black’, ‘black nappa’, ‘black nappa tote’,
‘nappa black nappa’]
  keywords_initial - l‘elena woven handbag’. ‘nappa black nappa handbag’, black nappa
handbag’, ‘black nappa tote handbag’,
  ‘black nappa black handbag’]
  keywords_combined - [ handbag’, elena woven
  ]
  keywords_final - [ ‘handbag’, ‘elena woven handbag’ ]
```

In another aspect, a method to generate recommendation includes:
capturing data from one or more business operational data sources;
extracting signals from one or more unstructured data sources;
automatically associating a product or a service with external content by:
characterizing the product from unstructured data sources including a product text or text from similar products;
generating a label for the product or service;
applying the label as a search engine;
extracting signals relating to the product or service;
adding data from a customer review by:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review;

generating one or more metrics from the operational data and unstructured data sources;
identifying one or more anomalies from the metrics; and
suggesting predetermined courses of action and estimated financial impact.

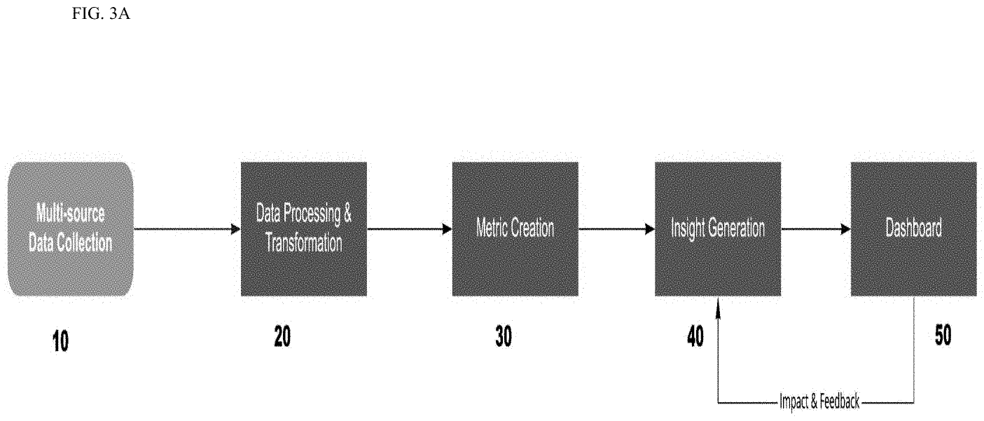

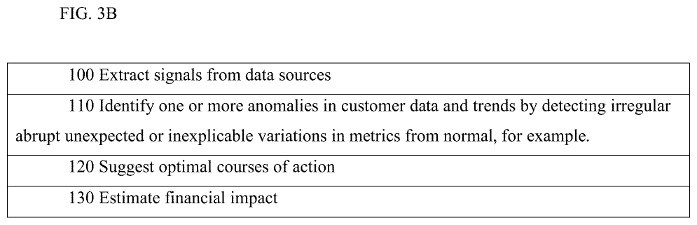

FIG. 3A shows a high-level view of an exemplary system that provides automated business intelligence from business data to improve operations of the business. The system extracts signals from any unstructured data source.

FIG. 3B shows an exemplary process to provide recommendations to users based on machine learning. The process includes:

100 Extract signals from data sources

110 Identify one or more anomalies in customer data and trends

120 Suggest optimal courses of action

130 Estimate financial impact

More details on the process of FIGS. 3A-3B are discussed in the co-pending incorporated by reference applications mentioned herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method to automatically associate a product or a service with external content, comprising:
characterizing the product from unstructured data sources including a product text or text from similar products;
generating a label for the product or service;
applying the label as a search engine;
extracting signals relating to the product or service; and
providing business intelligence for the product or service.

2. The method of claim 1, wherein the text extraction comprises selecting a predetermined number of text identified by TF-IDF (term frequency-inverse document frequency).

3. The method of claim 1, wherein the text extraction comprises applying an explainability of an attention model to see if the attention model provides one or more keywords or tokens to keep.

4. The method of claim 1, wherein the text extraction comprises obtaining a primary keyword from a search term and obtaining a secondary keyword from the primary keyword and labeling the product text by word-set-match or by zero-shot learning (ZSL).

5. The method of claim 1, wherein the text extraction comprises:
aggregating product titles and descriptions;
identifying n-grams and stopwords from the product titles and descriptions;
extraction by POS of tags to keep predetermined tags; and
determining term frequencies for each product and creating a bag-of-word (BOW).

6. The method of claim 5, comprising
representing the product or service as a multimedia file;
extracting meta data for the product or service corresponding to the multimedia file; and
discovering keywords that connect the image to external signals coming from social media, news articles, or search.

7. The method of claim 6, wherein the multimedia file comprises a picture or a video.

8. The method of claim 1, wherein the external content comprises one or more words in a search term.

9. The method of claim 1, comprising extracting signals from a social media site.

10. The method of claim 1, comprising extracting signals from a search engine.

11. A method to link a product or service to an external content, comprising:
discovering one or more keywords associated with the product or service; and
linking the product or service with the external content from social media.

12. The method of claim 11, wherein the text extraction comprises selecting a predetermined number of text identified by TF-IDF (term frequency-inverse document frequency).

13. The method of claim 11, wherein the text extraction comprises applying an explainability of an attention model to see if the attention model provides one or more keywords or tokens to keep.

14. The method of claim 11, wherein the text extraction comprises obtaining a primary keyword from a search term and obtaining a secondary keyword from the primary keyword and labeling the product text by word-set-match or by zero-shot learning (ZSL).

15. A method, comprising:
capturing data from one or more business operational data sources;
extracting signals from one or more unstructured data sources;
automatically associating a product or a service with external content by:
characterizing the product from unstructured data sources including a product text or text from similar products;
generating a label for the product or service;
applying the label as a search engine; and
extracting signals relating to the product or service;
adding data from a customer review by:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review;
generating one or more metrics from the operational data and unstructured data sources;
identifying one or more anomalies from the metrics; and
suggesting predetermined courses of action and estimated financial impact.
